(19) United States
(12) Patent Application Publication
(10) Pub. No.: US 2026/0120179 A1
(43) Pub. Date: Apr. 30, 2026

(54) SYSTEMS AND METHODS FOR PAYING INTEREST FOR ASSETS HELD IN NON-CUSTODIAL ACCOUNTS

(71) Applicant: ONLY X Inc., Roswell, GA (US)

(72) Inventors: Thomas T. Meredith, II, Roswell, GA (US); Morris Mwanga, Atlanta, GA (US)

(21) Appl. No.: 19/003,567

(22) Filed: Dec. 27, 2024

Related U.S. Application Data
(60) Provisional application No. 63/615,074, filed on Dec. 27, 2023.

(51) Int. Cl. G06Q 40/02

(52) U.S. Cl. CPC G06Q 40/02

(57) ABSTRACT

A smart-contract manager system for entering into an interest paying smart-contract for interest bearing tokens (IBTs) held in non-custodial accounts includes a graphical user interface (GUI); a processor; and a memory, including instructions stored thereon that, when executed by the processor, cause the system to: display prevailing interest rates for IBTs to a user; assess an allowability factor of the IBTs; analyze an interest rate of the prevailing interest rates and a volatility ratio of the IBTs; determine that the interest rate falls within a pre-determined risk tolerance; generate a smart-contract between the user and an entity; calculate a final interest rate; deposit an accrued interest in a liquidity pool; compound the accrued interest in the liquidity pool; and at least one of: transfer a payout to an account; or prompt the user to exchange the IBTs for a digital asset locked to a value of a reference asset.

### CROSS-REFERENCE TO RELATED APPLICATION AND CLAIM OF PRIORITY

This application claims the benefit of, and priority to, U.S. Patent Application Ser. No. 63/615,074 filed on Dec. 27, 2023, the entire content of which is hereby incorporated herein by reference.

### TECHNICAL FIELD

The subject matter of the present disclosure relates generally to entering into an interest paying smart-contract that enables non-custodial interest accrual and distribution for assets held in any compatible storage location in particular, for interest bearing tokens (IBTs) held in non-custodial accounts.

### BACKGROUND

Currently, interest earning assets need to be in the custody of the borrowing party or, alternatively, must be staked with any party other than the owner of the assets. This custody-related issue may lead to a heightened risk of loss, mismanagement, or misuse of the assets. In particular, when said assets are given to a borrower or a third-party intermediary, the owner of the assets essentially forfeits control and thus, exposes themself to potential for counterparty risk including, but not limited to, insolvency, fraud, and/or other operational failures. Further, this forfeiture of control may expose the owner of the assets to an increased risk of bankruptcy and otherwise improper collateral management, which could significantly harm the value of the owner's assets. Additionally, oftentimes, custody agreements entered into lack transparency, thus making it increasingly difficult for owners to monitor how their assets are being used and/or secured.

Accordingly, there is a need for systems and methods for entering into an interest-paying smart-contract that enables non-custodial interest accrual and distribution for assets held in any compatible storage location.

### SUMMARY

An aspect of the present disclosure provides a con smart-contract tract manager system for entering into an interest paying smart-contract for interest bearing tokens (IBTs) held in non-custodial accounts. The smart-contract manager system includes a graphical user interface (GUI) including a display; a processor; and memory. The memory includes instructions stored thereon, which, when executed by the processor, cause the system to display prevailing interest rates for IBTs to a user via the GUI; assess an allowability factor of the IBTs based on an optimum composition of the IBTs in an IBT pool; analyze an interest rate of the prevailing interest rates and a volatility ratio of the IBTs; determine that the interest rate falls within a pre-determined risk tolerance to approve the interest rate for smart-contract generation; generate a smart-contract between the user and an entity based on the determination that the interest rate falls within a pre-determined risk tolerance; calculate a final interest rate; deposit an accrued interest in a liquidity pool; compound the accrued interest in the liquidity pool; and at least one of: transfer a payout to an account; or prompt the user to exchange the IBTs for a digital asset locked to a value of a reference asset via the GUI. The payout is displayed to the user via the GUI.

In an aspect of the present disclosure, the instructions, when executed by the processor, may further cause the system to monitor, by the liquidity pool, the interest accrued by the user off-chain.

In another aspect of the present disclosure, the instructions, when executed by the processor, may further cause the system to monitor, by the liquidity pool, a cumulative interest accrued by the user off-chain.

In yet another aspect of the present disclosure, the instructions, when executed by the processor, may further cause the system to accumulate outgoing transactions off-chain. The outgoing transactions may include at least one of the transferred payouts or the exchanged IBTs.

In an aspect of the present disclosure, the instructions, when executed by the processor, may further cause the system to perform a zero-knowledge rollup of the accumulated outgoing transactions.

In another aspect of the present disclosure, the instructions, when executed by the processor, may further cause the system to: perform a zero-knowledge proof of the zero-knowledge rollup of the accumulated outgoing transactions; and add the accumulated transactions to a blockchain.

In yet another aspect of the present disclosure, the final interest rate may be calculated based on interest accrued after a period of time has passed from when the user and the entity entered into the smart-contract.

In an aspect of the present disclosure, the final interest rate may be one of a first rate or a second rate.

In another aspect of the present disclosure, the first rate may be configured to include a variable annual percentage yield (APY) and may be applied to the final interest rate calculation as a sample mean of a plurality of APYs supplied by an incoming oracle during an interest cycle.

In yet another aspect of the present disclosure, the first rate may be affected by the pre-determined risk tolerance.

In an aspect of the present disclosure, the second rate may include a fixed annual percentage yield (APY). The fixed APY may be used in the final interest calculation during the interest cycle.

In another aspect of the present disclosure, the digital asset locked to a value of a reference asset may be a stablecoin.

An aspect of the present disclosure provides a processor-implemented method for entering into an interest paying smart-contract for interest bearing tokens (IBTs) held in non-custodial accounts. The method includes displaying, by a processor, prevailing interest rates for IBTs to a user via a graphical user interface (GUI) including a display; assessing, by the processor, an allowability factor of the IBTs based on an optimum composition of the IBTs in an IBT pool; analyzing, by the processor, an interest rate of the prevailing interest rates and a volatility ratio of the IBTs; determining, by the processor, that the interest rate falls within a pre-determined risk tolerance to approve the interest rate for smart-contract generation; generating, by the processor, a smart-contract between the user and an entity based on the determination that the interest rate falls within a pre-determined risk tolerance; calculating, by the processor, a final interest rate; depositing, by the processor, an accrued interest in a liquidity pool; compounding, by the processor, the accrued interest in the liquidity pool; and at least one of: transferring, by the processor, a payout to an account; or prompting the user to exchange the IBTs for a digital asset locked to a value of a reference asset via the GUI. The payout is displayed to the user via the GUI.

In an aspect of the present disclosure, the method may further include monitoring, by the liquidity pool, the interest accrued by the user off-chain.

In another aspect of the present disclosure, the method may further include monitoring, by the liquidity pool, a cumulative interest accrued by the user off-chain.

In yet another aspect of the present disclosure, the method may further include accumulating outgoing transactions off-chain. The outgoing transactions may include at least one of the transferred payouts or the exchanged IBTs.

In an aspect of the present disclosure, the method may further include performing a zero-knowledge rollup of the accumulated outgoing transactions.

In another aspect of the present disclosure, the method may further include performing a zero-knowledge proof of the zero-knowledge rollup of the accumulated outgoing transactions; and adding the accumulated transactions to a blockchain.

In yet another aspect of the present disclosure, the method may further include exchanging the IBTs for a stablecoin.

An aspect of the present disclosure provides a non-transitory computer-readable medium storing a program that causes a computer to execute a computer-implemented method for entering into an interest paying smart-contract for interest bearing tokens (IBTs) held in non-custodial accounts. The computer-implemented method includes displaying, by a processor, prevailing interest rates for IBTs to a user via a graphical user interface (GUI) including a display; assessing, by the processor, an allowability factor of the IBTs based on an optimum composition of the IBTs in an IBT pool; analyzing, by the processor, an interest rate of the prevailing interest rates and a volatility ratio of the IBTs; determining, by the processor, that the interest rate falls within a pre-determined risk tolerance to approve the interest rate for smart-contract generation; generating, by the processor, a smart-contract between the user and an entity based on the determination that the interest rate falls within a pre-determined risk tolerance; calculating, by the processor, a final interest rate; depositing, by the processor, an accrued interest in a liquidity pool; compounding, by the processor, the accrued interest in the liquidity pool; and at least one of: transferring, by the processor, a payout to an account; or prompting the user to exchange the IBTs for a digital asset locked to a value of a reference asset via the GUI. The payout is displayed to the user via the GUI.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIGS. 1A and 1B are a flow diagram of a smart-contract manager system for entering into an interest paying smart-contract for interest bearing tokens (IBTs) held in non-custodial accounts, in accordance with aspects of the present disclosure;

FIG. 2 is a subsection of the flow diagram of the smart-contract manager system of FIGS. 1A and 1B, in accordance with aspects of the present disclosure;

FIG. 3 is a subsection of the flow diagram of the smart-contract manager system of FIGS. 1A and 1B, in accordance with aspects of the present disclosure;

FIG. 4 is a subsection of the flow diagram of the smart-contract manager system of FIGS. 1A and 1B, in accordance with aspects of the present disclosure; and

FIG. 5 a block diagram of a controller for the system of FIGS. 1A and 1B, in accordance with aspects of the present disclosure.

### DETAILED DESCRIPTION

The present disclosure relates generally to systems and methods for entering into an interest paying smart-contract that enables non-custodial interest accrual and distribution for assets held in any compatible storage location. More specifically, the present disclosure relates to interest bearing tokens (IBTs) held in non-custodial accounts.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Traditionally, interest-earning assets need to be in the custody of the borrowing party or, alternatively, must be staked with any party other than the owner of the assets, which may create to a plethora of issues, including, for example, a heightened risk of loss, mismanagement, or misuse of the assets. Namely, the owner of the assets essentially forfeits control and exposes themself to the potential for counterparty risk including, but not limited to, insolvency, fraud, operational failures, an increased risk of bankruptcy, and otherwise improper collateral management, which could significantly harm the value of the owner's assets. Further, traditionally stored interest-earning assets are typically not continuously monitored for fluctuations in appreciation or depreciation, leaving customers unaware of ideal times to buy or sell. Causing a customer to lose considerable amounts of money. For instance, a physical asset stored in a physical safe has the technical problem of the physical asset not being appraised in real-time to reflect changes in its value. Thus, if the value fluctuates, the customer cannot react to the asset fluctuation in a real-time manner. In contrast, the disclosed smart-contract manager system 100 provides the technical solution of enabling real-time monitoring of the appreciation and depreciation of interest-bearing assets, specifically Interest-Bearing Tokens (IBTs). This system provides users (e.g., customers) with up-to-date information on the value of their IBTs, including accrued interest, ensuring they remain informed and can make timely decisions.

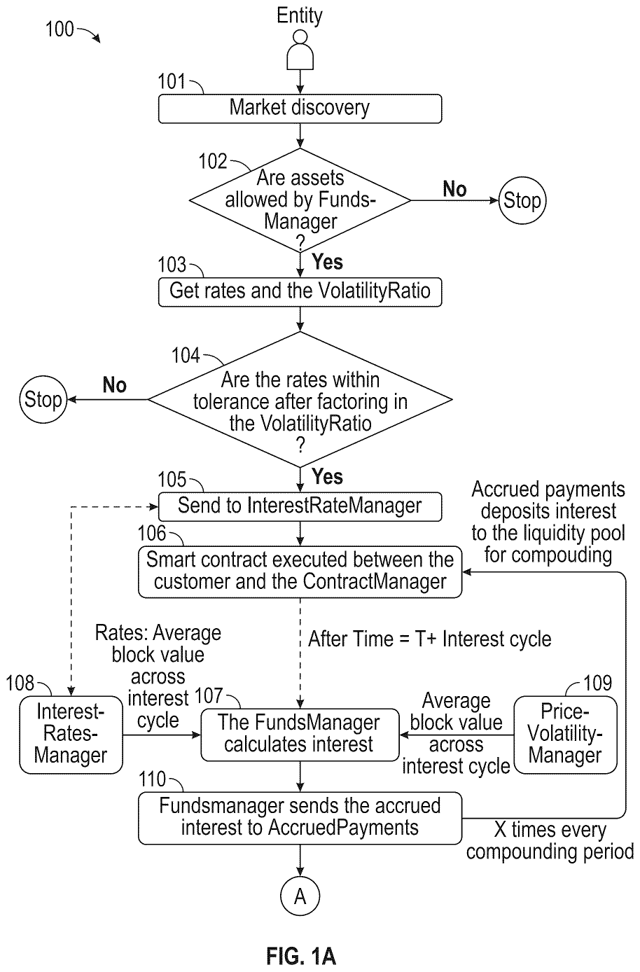

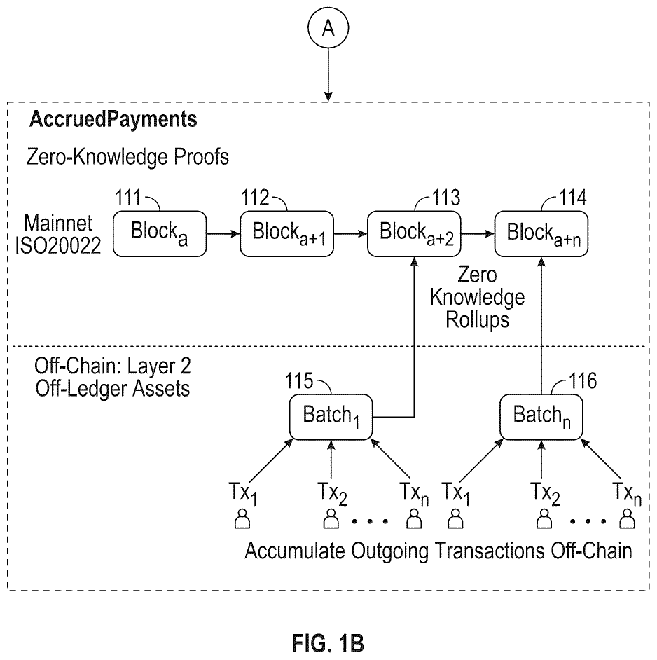

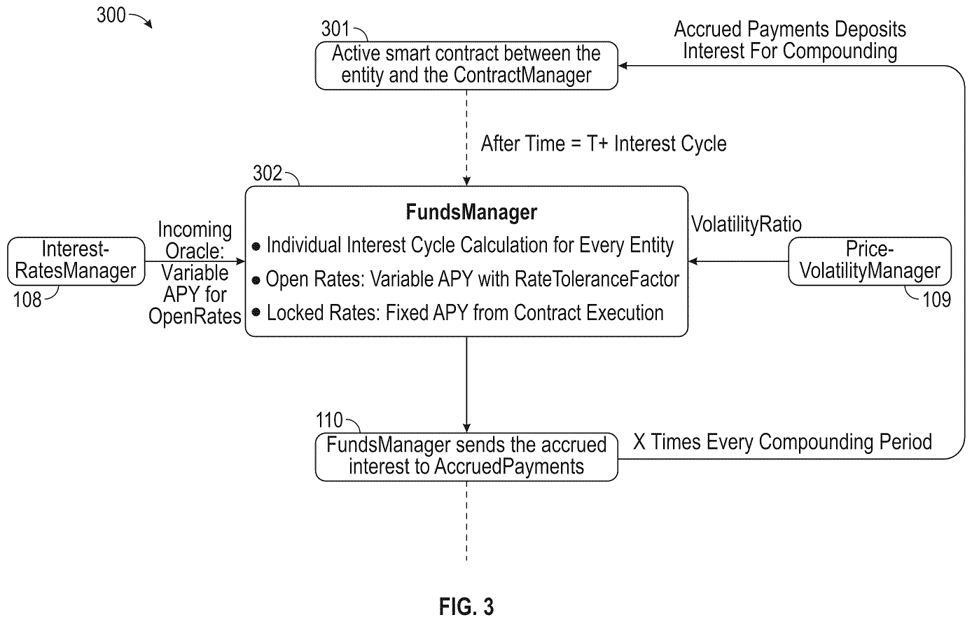

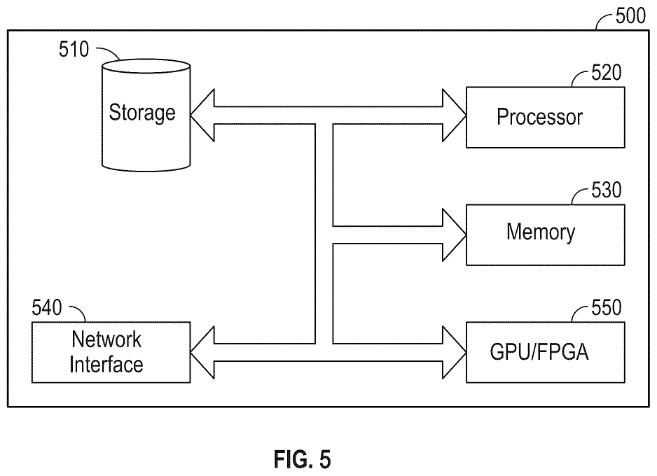

Referring to FIGS. 1A-5, a smart-contract manager system 100 for entering into an interest-paying smart-contract for interest bearing tokens (IBTs) held in non-custodial accounts is shown. The smart-contract manager system 100 includes a graphical user interface (GUI), including a display 540, which may be run on a controller 500 (FIG. 5). Controller 500 includes a processor 520 and a memory 530. Memory 530 includes instructions stored thereon that, when executed by processor 520, cause the system 100 to execute the various modules and processes of system 100. It is contemplated that the operations of system 100 may be executed either in a distributed manner, or by a single device, such as a server.

At operation 101, controller 500 causes system 100 to display prevailing interest rates for IBTs to a user (e.g., a customer) via GUI 540 such that the user may engage in market discovery. Engaging in market discovery to analyze prevailing interest rates allows customers of IBTs to maximize returns and make informed investment decisions. Interest rates impact the yield generated by IBTs and, as such, understanding market trends and comparing rates across various platforms allows customers to identify opportunities to invest in IBTs offering higher returns or divest from underperforming ones. Further, market discovery aids customers in assessing the risk-reward balance and adapting their strategies to changes in economic conditions, such as inflation or central bank policies, ensuring their investments remain aligned with their financial goals.

At operation 102, controller 500 causes system 100 to assess an allowability factor of the IBTs based on an optimum composition of the IBTs in an IBT pool. In aspects, a FundsManager module assesses whether the IBTs are allowed by analyzing the optimum composition of the IBTs based on a pool of cumulative IBT information. As used herein the term “module” includes software subroutines configured to execute a particular task. For example, Bitcoin (BTC) may possess an optimum composition of 20% and, as such, if the Bitcoin sought to be acquired by the user does not satisfy said optimum composition, the FundsManager module will reject the IBT. However, if the IBT is allowed by the FundsManager module, at operation 103 controller 500 causes system 100 to acquire interest rates for the IBT and assess a volatility ratio of the IBT. Analyzing the optimum composition of the IBT provides the benefit of helping users maximize returns while minimizing risks by ensuring the IBT's underlying assets are balanced. The composition of an IBT generally includes a combination of interest-earning instruments including loans, bonds, or staking assets, each with unique risk profiles, interest rates, and liquidity characteristics and, as such, by optimizing this mix of instruments, the user may enhance returns, mitigate risks, improve overall liquidity, and align with current market conditions to be able to dynamically respond to shifts in economic trends. The FundsManager module maintains and provides a list of IBTs that can earn interest and a swap-able pair of IBTs in a liquidity pool. The volatility ratio of the IBT is a metric that measures the degree of fluctuation in the IBTs value over a time period relative to its underlying interest-earning assets. The volatility ratio reflects the IBTs sensitivity to changes in market conditions, such as interest rate fluctuations, asset performance, or other external economic factors, and aids in risk assessment, performance monitoring, portfolio management, and comparative analysis. The volatility ratio is provided to system 100 by a PriceVoltalityManager module, which is a subcomponent of the FundsManager module.

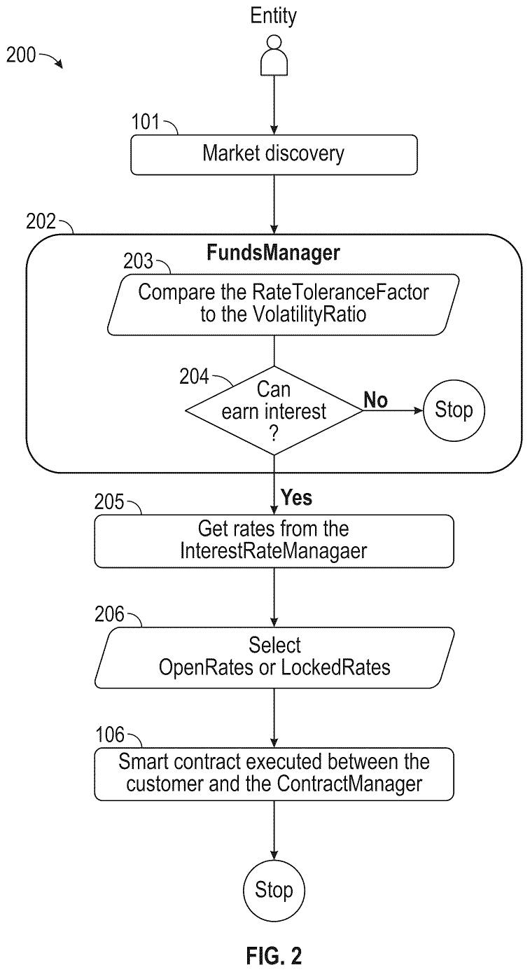

At operation 104, controller 500 causes system 100 to determine whether the interest rate falls within a pre-determined risk tolerance, after analyzing the volatility ratio, to approve the interest rate for smart-contract generation. The risk tolerance may be set by the user based on their particular risk appetite. Ensuring that the interest rate falls within the risk tolerance is critical as it ultimately directly affects the user's financial security and overall portfolio stability. Risk tolerance represents the user's ability and willingness to withstand fluctuations in value or potential losses. Ultimately, setting the risk tolerance allows the user to align returns with their individual comfort level, ensure the stability of their portfolio, manage their financial goals, and prudently maximize their returns. As illustrated in FIG. 2, at operations 202-204, the FundsManager module compares the risk tolerance to the volatility ratio to assess whether the IBT can earn interest. In the event that the interest rate does not fall within the risk tolerance, the interest rate is rejected. However, if the interest rate does fall within the risk tolerance, at operation 105, controller 500 causes system 100 to send the interest rate to an InterestRateManager module. At operation 205, the InterestRateManager module provides the interest rate expressed as Annual Percentage Yield (APY). At operation 206, the user receives available rate options from the InterestRateManager module and selects from two interest rate forms, either a first rate or a second rate, for their interest-earning strategy. The first rate is configured to include a variable annual percentage yield (APY) (e.g., an Open Rate) and is applied to a final interest rate calculation as a sample mean of a plurality of APYs supplied by an incoming oracle during an interest cycle. The first rate is affected by the pre-determined risk tolerance. On the contrary, second rate includes a fixed annual percentage yield (APY) (e.g., a Locked Rate) and the fixed APY is used in the final interest calculation during the interest cycle. The second rate is not affected by the pre-determined risk tolerance.

At operation 106, controller 500 causes system 100 to generate a smart-contract between the user and an entity based on the determination that the interest rate falls within the pre-determined risk tolerance. A smart contract is a form of self-executing contract where the terms of the agreement are written directly into lines of code and thus, it enforces the terms and conditions when certain predefined conditions are triggered, mitigating the need for third-party intermediaries. At operation 301, the smart contract is activated.

After a period of time has passed since smart contract generation, at operation 107, controller 500 causes system 100 to calculate a final interest rate via the FundsManager module, which is then, at operation 108, communicated to the InterestRateManager module. At operation 107, the final interest rate is determined as being an average block value across the interest cycle. At the end of every interest cycle, which is calculated as individual interest cycles for every user based on smart contract execution terms, the FundsManager module executes interest calculations with specific rate validations. As illustrated by operation 302, for users with first rate smart contracts, the FundsManager module first validates if the supplied variable APY falls within the risk tolerance bounds. If the supplied APY falls outside of these bounds, the interest calculation is skipped for that interest cycle. For entities with second rate smart contracts, interest calculations proceed with the fixed rate established at smart contract execution at operation 106. The InterestRateManager module supplies the interest rate to be utilized for interest accrued calculations.

At operation 109, controller 500 causes system 100 to transmit, via a PriceVoltalityManager module, the volatility ratio to the FundsManager module based on an average block value across the interest cycle. The volatility ratio is a factor in interest accrued calculations. Once completed, the FundsManager module calculates interest accrued based on all aforementioned inputs and records the interest accrued in an immutable record in a blockchain. Namely, at operation 110, controller 500 causes system 100 to transfer, via the FundsManager module, the interest accrued to a designated blockchain module (e.g., a liquidity pool 402). Liquidity pool 402 monitors the interest accrued by the user off-chain and further monitors a cumulative interest accrued by the user off-chain. For subsequent interest cycles, the FundsManager module implements compound interest calculation through two mechanisms. First, accrued interest is automatically added to a principal value for the next interest cycle's calculations. Second, any unpaid accrued interest from previous cycles is incorporated into compound interest calculations until claimed by the user. This dual-compounding mechanism applies only to unclaimed interest payments. On the contrary, once interest is paid out, system 100 excludes the interest amount from future compounding calculations. This compounding process is tracked in the blockchain's immutable record, ensuring accurate interest accrual across extended periods of unclaimed payments. System 100 factors the accrued payments into any future interest calculations. Accordingly, the user is provided with visibility into their current earnings, including pending payments of interest accrued.

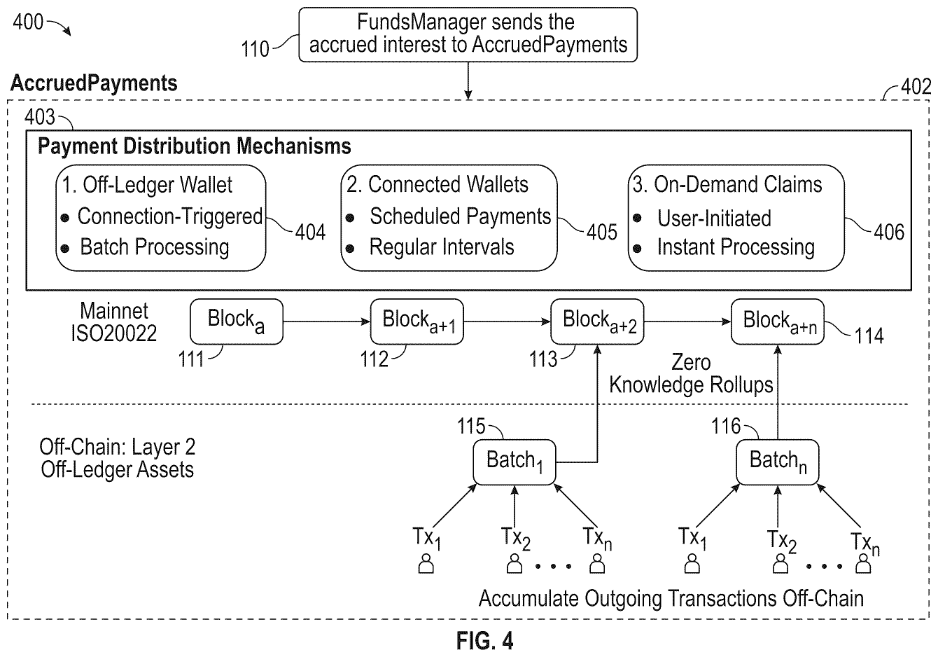

FIG. 4 illustrates a payout process 400 wherein after the FundsManager module transfers accrued interest to a designated blockchain module, such as liquidity pool 402, as illustrated by operation 110, the user is provided with three main payment distribution mechanisms 403. First, at operation 404, the user may choose to transfer the accrued interest to an off-ledger wallet, which is connection-triggered and utilizes batch processing. Off-ledger wallets provide enhanced security, privacy, and flexibility in managing these IBTs. Second, at operation 405, the user may choose to transfer the accrued interest to a connected wallet that has scheduled payments and is set at regular intervals. Third, at operation 406, the user may choose to put forth an on-demand claim that is user-initiated and has instant processing. To optimize throughput and minimize transaction costs, interest payments are distributed through multiple channels, primarily off-chain through Layer 2 blockchain infrastructure illustrated by Batch₁ 115 and Batchₙ 116 utilizing Zero-Knowledge Proofs, while also leveraging standardized financial messaging channels via ISO20022 as illustrated by Blockₐ 111, Blockₐ₊₁ 112, Blockₐ₊₂ 113, and Blockₐ₊ₙ 114. The user is also provided with the option to exchange the IBTs for a digital asset locked to a value of a reference asset via the GUI. The digital asset locked to the value of a reference asset may be a stablecoin, such as, but not limited to, Tether, USDD, USD Coin, Paxos Gold, or Pax Dollar. Stablecoins maintain a stable value by locking their worth to a specific asset or a plethora of assets, offering users enhanced speed, transparency, and stabilized price volatility.

Controller 500 further causes system 100 to accumulate outgoing transactions off-chain. The outgoing transactions may include, for example, at least one of the transferred payouts or the exchanged IBTs. Additionally, controller 500 causes system 100 to perform a zero-knowledge rollup of the accumulated outgoing transactions, perform a zero-knowledge proof of the zero-knowledge rollup of the accumulated outgoing transactions and add the accumulated transactions to a blockchain. Zero-knowledge proofs are a cryptographic method that enables multiple parties to verify a transaction's veracity without revealing any information beyond the transaction itself. Zero-knowledge rollup processes some transactions off-chain, then submit a summary of the transactions and a cryptographic proof to the main chain. The proof verifies the validity of the transactions without requiring all the details to be stored on-chain. The zero-knowledge rollup is configured to move computation and state off-chain into one or more off-chain networks while storing transaction data on-chain on a layer-1 network (for example, Ethereum). State changes are computed off-chain and are then proven as valid on-chain using the zero-knowledge proof.

FIG. 5 illustrates exemplary components in the controller 500 in accordance with aspects of the present disclosure including, for example, a database 510, one or more processors 520, at least one memory 530, and a graphical user interface (GUI) including a display 540. In aspects, the controller 500 may include a graphical processing unit (GPU) 550.

Database 510 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray disc, or the like. In various embodiments, data may be stored on the controller 500, including, for example, user preferences, historical data, and/or other data. The data can be stored in database 510 and sent via the system bus to the processor 520.

The processor 520 executes various processes based on instructions that can be stored in the server memory 530 and utilizing the data from the database 510. The illustration of FIG. 5 is exemplary, and it will be understood by persons skilled in the art that other components may exist in a controller 500. Such other components are not illustrated in FIG. 5 for clarity of illustration.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

What is claimed is:

1. A smart-contract manager system for entering into an interest paying smart-contract for interest bearing tokens (IBTs) held in non-custodial accounts, comprising:
a graphical user interface (GUI) including a display;
a processor; and
a memory, including instructions stored thereon that, when executed by the processor, cause the system to:
display prevailing interest rates for IBTs to a user via the GUI;
assess an allowability factor of the IBTs based on an optimum composition of the IBTs in an IBT pool;
analyze an interest rate of the prevailing interest rates and a volatility ratio of the IBTs;
determine that the interest rate falls within a pre-determined risk tolerance to approve the interest rate for smart-contract generation;
generate a smart-contract between the user and an entity based on the determination that the interest rate falls within a pre-determined risk tolerance;
calculate a final interest rate;
deposit an accrued interest in a liquidity pool;
compound the accrued interest in the liquidity pool; and
at least one of:
transfer a payout to an account, wherein the payout is displayed to the user via the GUI; or
prompt the user to exchange the IBTs for a digital asset locked to a value of a reference asset via the GUI.

2. The smart-contract manager system of claim 1, wherein the instructions, when executed by the processor, further cause the system to:
monitor, by the liquidity pool, the interest accrued by the user off-chain.

3. The smart-contract manager system of claim 1, wherein the instructions, when executed by the processor, further cause the system to:
monitor, by the liquidity pool, a cumulative interest accrued by the user off-chain.

4. The smart-contract manager system of claim 1, wherein the instructions, when executed by the processor, further cause the system to:
accumulate outgoing transactions off-chain, wherein the outgoing transactions include at least one of the transferred payouts or the exchanged IBTs.

5. The smart-contract manager system of claim 4, wherein the instructions, when executed by the processor, further cause the system to:
perform a zero-knowledge rollup of the accumulated outgoing transactions.

6. The smart-contract manager system of claim 5, wherein the instructions, when executed by the processor, further cause the system to:
perform a zero-knowledge proof of the zero-knowledge rollup of the accumulated outgoing transactions; and
add the accumulated transactions to a blockchain.

7. The smart-contract manager system of claim 1, wherein the final interest rate is calculated based on interest accrued after a period of time has passed from when the user and the entity entered into the smart-contract.

8. The smart-contract manager system of claim 7, wherein the final interest rate is one of a first rate or a second rate.

9. The smart-contract manager system of claim 8, wherein the first rate is configured to include a variable annual percentage yield (APY) and is applied to the final interest rate calculation as a sample mean of a plurality of APYs supplied by an incoming oracle during an interest cycle.

10. The smart-contract manager system of claim 9, wherein the first rate is affected by the pre-determined risk tolerance.

11. The smart-contract manager system of claim 9, wherein the second rate includes a fixed annual percentage yield (APY) and wherein the fixed APY is used in the final interest calculation during the interest cycle.

12. The smart-contract manager system of claim 1, wherein the digital asset locked to a value of a reference asset is a stablecoin.

13. A processor-implemented method for entering into an interest paying smart-contract for interest bearing tokens (IBTs) held in non-custodial accounts, comprising:
displaying, by a processor, prevailing interest rates for IBTs to a user via a graphical user interface (GUI) including a display;
assessing, by the processor, an allowability factor of the IBTs based on an optimum composition of the IBTs in an IBT pool;
analyzing, by the processor, an interest rate of the prevailing interest rates and a volatility ratio of the IBTs;
determining, by the processor, that the interest rate falls within a pre-determined risk tolerance to approve the interest rate for smart-contract generation;
generating, by the processor, a smart-contract between the user and an entity based on the determination that the interest rate falls within a pre-determined risk tolerance;
calculating, by the processor, a final interest rate;
depositing, by the processor, an accrued interest in a liquidity pool;
compounding, by the processor, the accrued interest in the liquidity pool; and
at least one of:
transferring, by the processor, a payout to an account, wherein the payout is displayed to the user via the GUI; or
prompting the user to exchange the IBTs for a digital asset locked to a value of a reference asset via the GUI.

14. The processor-implemented method of claim 13, further comprising:
monitoring, by the liquidity pool, the interest accrued by the user off-chain.

15. The processor-implemented method of claim 13, further comprising:
monitoring, by the liquidity pool, a cumulative interest accrued by the user off-chain.

16. The processor-implemented method of claim 13, further comprising:
accumulating outgoing transactions off-chain, wherein the outgoing transactions include at least one of the transferred payouts or the exchanged IBTs.

17. The processor-implemented method of claim 16, further comprising:
performing a zero-knowledge rollup of the accumulated outgoing transactions.

18. The processor-implemented method of claim 17, further comprising:
performing a zero-knowledge proof of the zero-knowledge rollup of the accumulated outgoing transactions; and
adding the accumulated transactions to a blockchain.

19. The processor-implemented method of claim 11, further comprising:
exchanging the IBTs for a stablecoin.

20. A non-transitory computer-readable medium storing a program that causes a computer to execute a computer-implemented method for entering into an interest paying smart-contract for interest bearing tokens (IBTs) held in non-custodial accounts, the computer-implemented method comprising:
displaying, by a processor, prevailing interest rates for IBTs to a user via a graphical user interface (GUI) including a display;
assessing, by the processor, an allowability factor of the IBTs based on an optimum composition of the IBTs in an IBT pool;
analyzing, by the processor, an interest rate of the prevailing interest rates and a volatility ratio of the IBTs;
determining, by the processor, that the interest rate falls within a pre-determined risk tolerance to approve the interest rate for smart-contract generation;
generating, by the processor, a smart-contract between the user and an entity based on the determination that the interest rate falls within a pre-determined risk tolerance;
calculating, by the processor, a final interest rate;
depositing, by the processor, an accrued interest in a liquidity pool;
compounding, by the processor, the accrued interest in the liquidity pool; and
at least one of:
transferring, by the processor, a payout to an account, wherein the payout is displayed to the user via the GUI; or
prompting the user to exchange the IBTs for a digital asset locked to a value of a reference asset via the GUI.
